(19) United States
(12) Patent Application Publication
(10) Pub. No.: US 2020/0061563 A1
(43) Pub. Date: Feb. 27, 2020

(54) EMULSIFIED DISPERSION LIQUID

(71) Applicant: BeRyu Co., Ltd., Osaka (JP)

(72) Inventor: Mitsuru NAKANO, Osaka (JP)

(73) Assignee: BeRyu Co., Ltd., Osaka (JP)

(21) Appl. No.: 16/533,605

(22) Filed: Aug. 6, 2019

(30) Foreign Application Priority Data
Aug. 22, 2018 (JP) 2018-155282

(51) Int. Cl. B01F 17/00

(52) U.S. Cl. CPC B01F 17/0007; B01F 17/0092; B01F 17/0028

(57) ABSTRACT

An emulsified dispersion liquid in which thin-film graphite et al. are used instead of a surfactant as an emulsifier. An emulsified dispersion liquid containing a medium liquid, an emulsification/dispersion material insoluble in the medium liquid, a thin-film graphite; and a carbon nanotube is disclosed. The emulsification/dispersion material is dispersed in the medium liquid in a state of being surrounded by the thin-film graphite with the carbon nanotube adhering to the surface of the thin-film graphite. An emulsified dispersion liquid containing a medium liquid, an emulsification/dispersion material insoluble in the medium liquid, and a carbon nanotube is disclosed. The emulsification/dispersion material is dispersed in the medium liquid in a state of being surrounded by the carbon nanotube.

### BACKGROUND OF THE INVENTION

### 1. Field of the Invention

The present invention relates to an emulsified dispersion liquid and, more particularly, to an emulsified dispersion liquid in which thin-film graphite is used as an emulsifier.

### 2. Description of the Related Art

When an emulsified dispersion liquid is manufactured by emulsifying or dispersing a liquid or solid emulsification/dispersion material in a medium liquid, a surfactant is generally used as an emulsifier. For example, it is known that oil can be emulsified and dispersed in water by using a surfactant (see, e.g., Japanese Laid-Open Patent Publication No. 2018-83769).

However, if an emulsified dispersion liquid may come into contact with the human body, for example, if the emulsified dispersion liquid is cosmetics or food, the surfactant may be harmful to the human body.

In this regard, studies were conducted for producing an emulsified dispersion liquid by using thin-film graphite such as graphene as an emulsifier instead of the surfactant that may be harmful to the human body.

However, this has a problem that even if the emulsification/dispersion material is emulsified or dispersed to produce the emulsified dispersion liquid, a stable emulsified dispersion liquid cannot be obtained since graphite thin films aggregate with each other over time.

### SUMMARY OF THE INVENTION

Therefore, as a result of intensive studies, the present inventor found that graphite thin films can be prevented from aggregating with each other by using thin-film graphite as an emulsifier and further adding a carbon nanotube, thereby completing the present invention.

Thus, an object of the present invention is to provide an emulsified dispersion liquid in which thin-film graphite etc. are used instead of a surfactant as an emulsifier.

The present invention provides an emulsified dispersion liquid comprising: a medium liquid; an emulsification/dispersion material insoluble in the medium liquid; a thin-film graphite; and a carbon nanotube, wherein the emulsification/dispersion material is dispersed in the medium liquid in a state of being surrounded by the thin-film graphite with the carbon nanotube adhering to the surface of the thin-film graphite.

The present invention provides an emulsified dispersion liquid comprising: a medium liquid; an emulsification/dispersion material insoluble in the medium liquid; and a carbon nanotube, wherein the emulsification/dispersion material is dispersed in the medium liquid in a state of being surrounded by the carbon nanotube.

In the emulsified dispersion liquid according to the present invention, a thin-film graphite and a carbon nanotube are used instead of a surfactant as an emulsifier to provide the emulsified dispersion liquid that is safe even when coming into contact with the human body.

### BRIEF DESCRIPTION OF THE DRAWINGS

FIG. 1 is a schematic showing an emulsified state of an oil particle according to an embodiment of the present invention;

FIG. 2 is a schematic of an emulsified dispersion liquid according to the embodiment of the present invention;

FIG. 3 is a schematic when the emulsified dispersion liquid according to the embodiment of the present invention is used in a drug/material delivery system;

FIG. 4 is a system configuration diagram of an emulsified dispersion liquid manufacturing system according to the embodiment of the present invention;

FIG. 5 is a schematic showing a configuration of first and second emulsification/dispersion devices constituting the emulsified dispersion liquid manufacturing system shown in FIG. 4;

FIG. 6 is a schematic showing an emulsification step according to the embodiment of the present invention;

FIG. 7 is a schematic showing a configuration of a multistage pressure/temperature control device constituting the emulsified dispersion liquid manufacturing system shown in FIG. 4;

FIG. 8 is a graph showing a form of positional change in pressure of the emulsified dispersion liquid in the multistage pressure/temperature control device; and

FIG. 9 is a photomicrograph of the emulsified dispersion liquid according to the embodiment of the present invention.

### DETAILED DESCRIPTION OF THE PREFERRED EMBODIMENTS

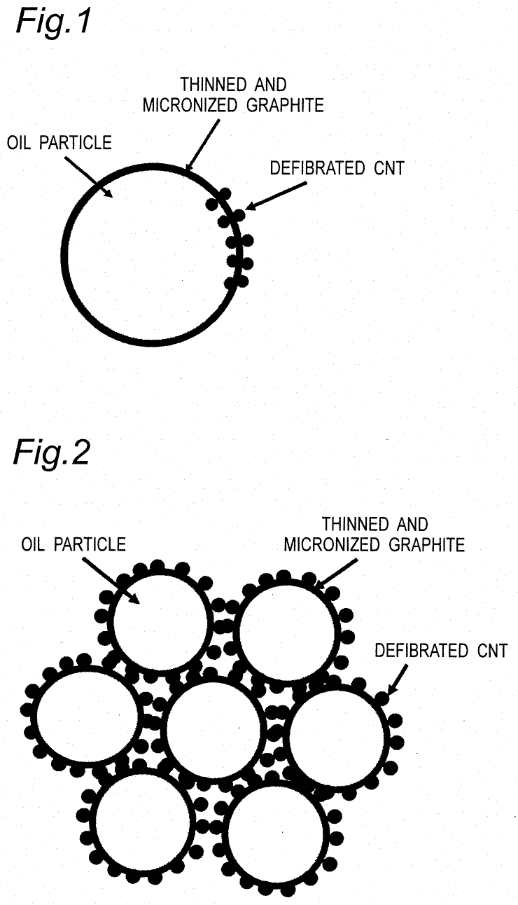

An emulsified dispersion liquid according to an embodiment of the present invention is an emulsified dispersion liquid basically composed of a medium liquid, an emulsification/dispersion material insoluble in the medium liquid, a thin-film graphite, and a carbon nanotube (CNT) and, as shown in FIG. 1, the emulsification/dispersion material (e.g., oil particle) is surrounded by the thinned and micronized thin-film graphite (graphite) and dispersed in the medium liquid with the defibrated carbon nanotube adhering to the surface of the thin-film graphite.

For example, water, methanol, ethanol etc. are used as the medium liquid, and an oil such as mineral oil or liquid paraffin is used as the emulsification/dispersion material. The oil may also contain another substance such as silicon oxide (SiOx). By adding a lipophilic substance in this way, the emulsified dispersion liquid can also be used as a distribution liquid of this substance. The melting point of the emulsification/dispersion material is preferably lower than the melting point of the thin-film graphite and the carbon nanotube.

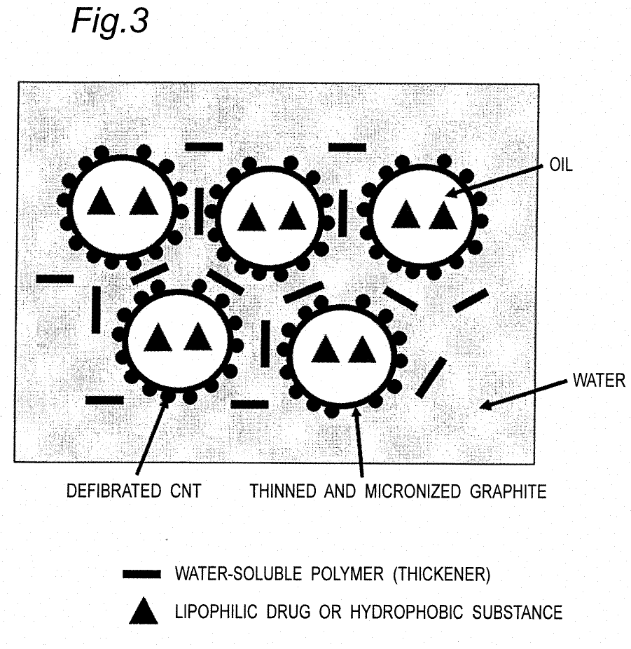

FIG. 3 is a schematic when the emulsified dispersion liquid according to the embodiment of the present invention is used in a drug/material delivery system. By mixing a lipophilic drug or a hydrophobic substance with the emulsification/dispersion material (e.g., oil), the drug or the substance can be retained and distributed. For example, mixing a silicon oxide enables application to a battery electrode material.

The thin-film graphite such as graphene has lipophilicity and hydrophobicity. Therefore, when the emulsified dispersion liquid contains the thin-film graphite, the thin-film graphite adheres to the surface of the emulsification/dispersion material to surround the material and can be dispersed in the medium liquid in this state. Thus, the thin-film graphite functions as an emulsifier instead of a surfactant.

On the other hand, since the thin-film graphite has an easily aggregating property, the graphite thin films covering the surface of the emulsification/dispersion material aggregate with each other. In the embodiment of the present invention, as shown in FIG. 2, the emulsified dispersion liquid contains the defibrated carbon nanotube, and the carbon nanotube adheres to the surface of the thin-film graphite. Since the carbon nanotube adheres to the thin-film graphite, the carbon nanotube functions as a spacer to prevent the graphite thin films surrounding the emulsification/dispersion material from coming into contact with each other, so that the aggregation of the thin-film graphite can be prevented.

The thin-film graphite is graphite exfoliated into thin films to the extent that the graphite can surround the surface of the spherical emulsification/dispersion material and is, for example, graphite formed of a single layer to several tens of layers, preferably a single layer to several layers. For example, the graphite has a length of 10 to 20 μm and about 4 to 30 layers.

The carbon nanotube is a defibrated single carbon nanotube or multi carbon nanotube and is preferably defibrated and divided to the extent that the carbon nanotube easily adheres to a surface of graphite.

The emulsified dispersion liquid preferably further contains a thickener (dispersant) such as sodium carboxymethylcellulose (CMC) and xanthan gum. When the medium liquid is water, a water-soluble polymer is used as the thickener. By using such a thickener, the aggregation of the carbon nanotube can be suppressed so as to allow the carbon nanotube to uniformly adhere onto the surface of graphite.

The emulsified dispersion liquid according to the embodiment of the present invention is an emulsified dispersion liquid containing the medium liquid, the emulsification/dispersion material insoluble in the medium liquid, and the carbon nanotube, and the emulsification/dispersion material may be dispersed in the medium liquid in a state of being surrounded by the carbon nanotube.

Even in this case, the emulsified dispersion liquid preferably further contains a thickener (dispersant) such as sodium carboxymethylcellulose (CMC) and xanthan gum. By containing the thickener, the aggregation of the carbon nanotube can be suppressed.

As described above, in the emulsified dispersion liquid according to the embodiment of the present invention, since the thin-film graphite is used instead of a surfactant as an emulsifier, the thin-film graphite surrounds the periphery of the emulsification/dispersion material, so that the emulsification/dispersion material can be dispersed or emulsified in the medium liquid. Furthermore, the carbon nanotube adheres to the surface of the thin-film graphite and functions as a spacer to prevent the graphite thin films covering the periphery of the emulsification/dispersion material from aggregating with each other. This enables provision of the emulsified dispersion liquid that is safe and stable even when coming into contact with the human body.

Additionally, when the carbon nanotube is used as an emulsifier, the carbon nanotube surrounds the periphery of the emulsification/dispersion material, so that the emulsification/dispersion material can be dispersed or emulsified in the medium liquid. This enables provision of the emulsified dispersion liquid that is safe and stable even when coming into contact with the human body.

The emulsified dispersion liquid according to the embodiment of the present invention can be used not only for cosmetics and food coming into contact with, the human body, but also for lubricants for machines, battery materials etc. Particularly, a water-soluble lubricant obtained by emulsifying and dispersing a lubricating oil in water is conventionally used as a lubricant for machining and has a problem of a high disposal cost. Since no surfactant is used in the emulsified dispersion liquid according to the embodiment of the present invention, the disposal cost is lowered.

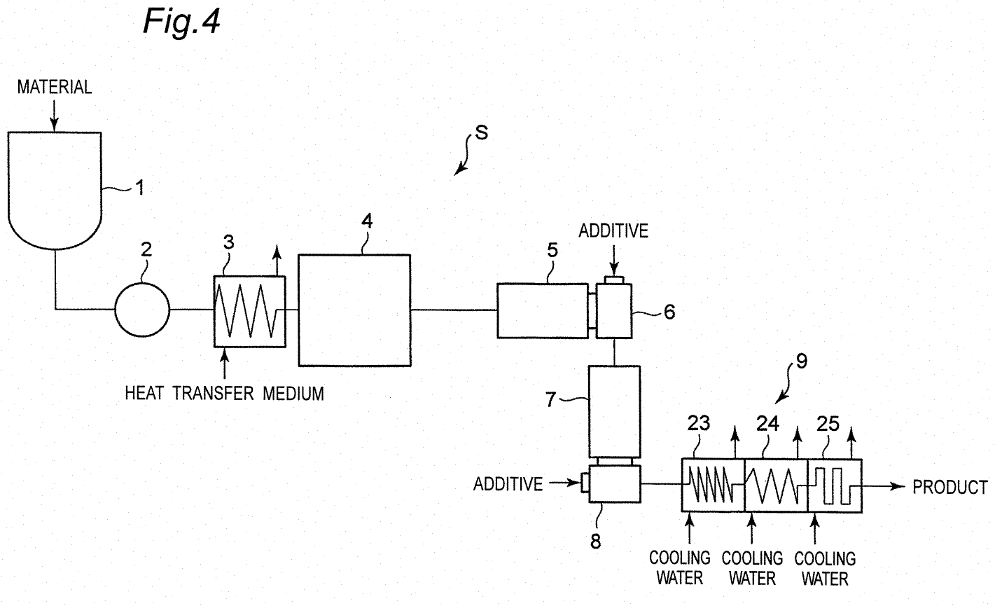

A method of manufacturing the emulsified dispersion liquid according to the embodiment of the present invention will be described with reference to FIGS. 4 to 9. An apparatus and a method used for manufacturing an emulsified dispersion liquid are described in detail in U.S. Pat. Nos. 5,791,124 2 and 5,972,434 of the same applicant.

FIG. 4 is a configuration diagram of an emulsified dispersion liquid manufacturing system, which is generally denoted by S, used for manufacturing the emulsified dispersion liquid according to the embodiment of the present invention. As shown in FIG. 4, the emulsified dispersion liquid manufacturing system S has a mixed liquid supply tank 1, a mixed liquid pressure transfer pump 2, a heat exchanger 3, a mixed liquid pressurizing pump 4, a first emulsification/dispersion device 5, a first additive supply port 6, a second emulsification/dispersion device 7, a second additive supply port 8, and a multistage pressure/temperature control device 9 in order from the upstream side to the downstream side with respect to a flow direction of a mixed liquid that is a raw material or the emulsified dispersion liquid that is a product.

In the mixed liquid supply tank 1, a mixed liquid containing a medium liquid and an emulsification/dispersion material insoluble in the medium liquid is stored. The followings are stored as the mixed liquid in the mixed liquid supply tank 1:
a medium liquid: 125 g of water;
an emulsification/dispersion material: 5 g of liquid paraffin;
an emulsifier: 0.3 g of thin-film graphite;
0.6 g of multi-wall carbon nanotube (MWCNT); and
a thickener: 0.3 g of sodium carboxymethylcellulose (CMC).

An agitator (not shown) is additionally disposed on the mixed liquid supply tank 1, and the agitator constantly agitates the mixed liquid so that the emulsification/dispersion material is macroscopically substantially uniformly distributed in the medium liquid. As used herein, the “emulsification/dispersion material” means a material to be emulsified or dispersed in the medium liquid.

The mixed liquid in the mixed liquid supply tank 1 is supplied by the mixed liquid pressure transfer pump 2 at a predetermined flow rate via the heat exchanger 3 to the mixed liquid pressurizing pump 4. The heat exchanger 3 uses a suitable heat transfer medium, for example, steam, high temperature water (e.g., 80 to 100° C.), or high temperature mineral oil (e.g., 100 to 500° C.), to heat the mixed liquid to a predetermined temperature suitable for emulsification/dispersion of the emulsification/dispersion material in water. For the heat exchanger 3, for example, a double-pipe type heat exchanger, a coil type heat exchanger, a plate type heat exchanger etc. are usable. In some cases, the mixed liquid may be cooled rather than heated. In this case, for example, low temperature water (e.g., 0 to 5° C.) or low temperature refrigerant (e.g., −20 to 0° C.) may be used as the heat transfer medium. If it is not necessary to adjust the temperature of the mixed liquid, the heat exchanger 3 may not be included.

The mixed liquid pressurizing pump 4 pressurizes the mixed liquid supplied from the mixed liquid pressure transfer pump 2 via the heat exchanger 3 to, for example, 30 to 300 MPa (300 to 3000 bars) before discharges it to the downstream side. In this description, the mixed liquid is pressurized to 100 MPa. The high-pressure mixed liquid discharged from the mixed liquid pressurizing pump 4 is first supplied to the first emulsification/dispersion device 5 while maintaining the high pressure. As described in detail later, the first emulsification/dispersion device 5 emulsifies and disperses the emulsification/dispersion material, the thin-film graphite, and the multi-wall carbon nanotube in the medium liquid by liquid/liquid shearing using a jet flow so as to generate an emulsified dispersion liquid before discharge to the downstream side. If a portion of the emulsification/dispersion material etc. is not emulsified and dispersed in the medium liquid, the emulsification/dispersion material etc. are emulsified and dispersed by the second emulsification/dispersion device 7 described later. As used herein, the “emulsified dispersion liquid” means a liquid (e.g., an emulsion or a suspension) in which the material to be emulsified and/or the material to be dispersed is emulsified or dispersed in the medium liquid.

As described above, when the emulsification/dispersion material, the thin-film graphite, and the multi-wall carbon nanotube are passed through the first emulsification/dispersion device 5, the emulsification/dispersion material is surrounded by the thinned and micronized thin-film graphite and dispersed in the medium liquid with the defibrated carbon nanotube adhering to the surface of the thin-film graphite, thereby forming the emulsified dispersion liquid.

The emulsified dispersion liquid discharged from the first emulsification/dispersion device 5 is supplied through the first additive supply port 6 to the second emulsification/dispersion device 7. If the emulsification/dispersion material etc. are present without being emulsified/dispersed in the emulsified dispersion liquid generated by the first emulsification/dispersion device 5, the second emulsification/dispersion device 7 emulsifies and disperses the emulsification/dispersion material in the medium liquid by basically the same liquid/liquid shearing as the first emulsification/dispersion device 5 so as to generate the emulsified dispersion liquid in which the emulsification/dispersion material is completely emulsified and discharged, before discharge to the downstream side. If the emulsification/dispersion material is sufficiently emulsified and dispersed by the first emulsification/dispersion device 5, the second emulsification/dispersion device 7 may not be included.

The emulsified dispersion liquid discharged from the second emulsification/dispersion device 7 is supplied via the second additive supply port 8 to the multistage pressure/temperature control device 9. In the production of the emulsified dispersion liquid according to the embodiment of the present invention, no additive is added from the first additive supply port 6 and the second additive supply port 8.

As described in detail later, the multistage pressure/temperature control device 9 applies a predetermined back pressure to the emulsified dispersion liquid in the second emulsification/dispersion device 7 and the emulsified dispersion liquid in the first emulsification/dispersion device 5 to prevent occurrence of bubbling inside the first and second emulsification/dispersion devices 5, 7 and reduces the pressure of the generated emulsified dispersion liquid stepwise or gradually to lower the pressure of the emulsified dispersion liquid at an outlet part of the multistage pressure/temperature control device 9 to such a pressure that no bubbling occurs even when the emulsified dispersion liquid is released under the atmospheric pressure, for example, to the atmospheric pressure.

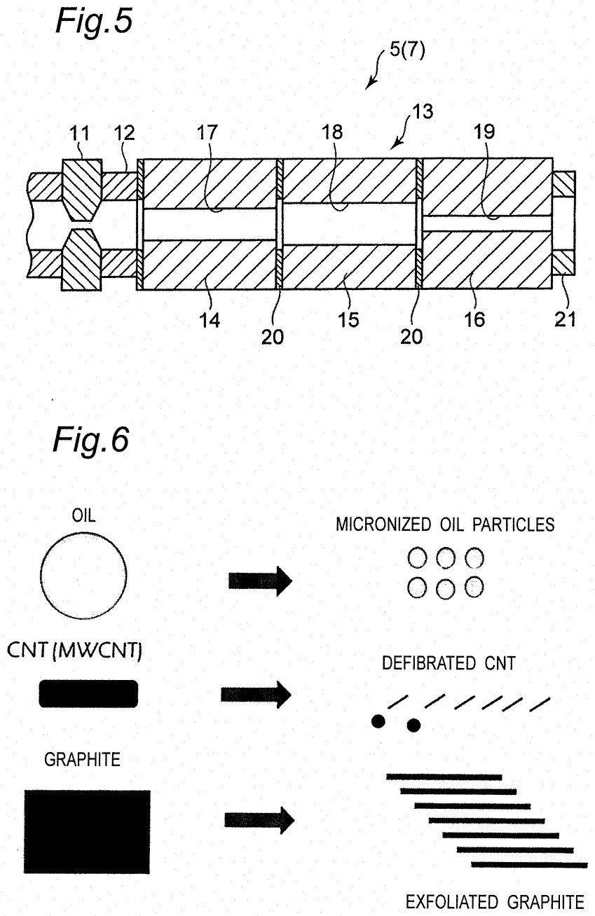

FIG. 5 is a view schematically showing the structure of the first emulsification/dispersion device 5. The structure and function of the second emulsification/dispersion device are substantially the same as the first emulsification/dispersion device 5 shown in FIG. 5, and therefore, the structure and function of the first emulsification/dispersion device 5 will hereinafter mainly be described so as to avoid redundant description. As shown in FIG. 5, the first emulsification/dispersion device 5 includes a nozzle member 11, a cylindrical passage member 12, and a substantially columnar main body part 13 connected in series to each other.

The nozzle member 11, the passage member 12, and the main body part 13 are arranged such that central axes thereof are in a straight line, i.e., coaxially. The main body part 13 includes first to third pore members 14 to 16 arranged in order from the upstream side to the downstream side with respect to the flow direction of the mixed liquid or the emulsified dispersion liquid (rightward in the positional relationship in FIG. 5). The first to third pore members 14 to 16 respectively have columnar-shaped first to third pores 17 to 19 penetrating the first to third pore members 14 to 16 in a central axis direction. The first to third pore members 14 to 16 are connected to each other via a ring-shaped seal member 20.

Assuming that the inner diameters of the first to third pores 17 to 19 of the first to third pore members 14 to 16 are d₁, d₂, d₃, respectively, the inner diameters d₁, d₂, d₃ are set to satisfy the relationship of d_{2>}d₁>d₃. The inner diameter of the cylindrical passage member 12 is set to a value larger than d₂. The inner diameter of the passage member 12 may be equal to d₂. The inner diameter of each of the seal members 20 is set to a value larger than d₂. The inner diameters of the first to third pore members 14 to 16 are preferably set, for example, in a range of 0.4 to 4 mm depending on properties of the mixed liquid or the emulsified dispersion liquid, and the length thereof is preferably set in a range of 4 to 40 mm, for example. The inner diameter of the nozzle member 11 is preferably set, for example, in a range of 0.1 to 0.5 mm depending on properties of the mixed liquid or the emulsified dispersion liquid, and the nozzle length is preferably set in a range of 1 to 4 mm, for example. The inner diameter of the seal members 20 is preferably set in a range of 2 to 8 mm, for example.

In the first emulsification/dispersion device 5, the first pore member 14 or the first pore 17 relatively small in diameter applies a predetermined back pressure to the mixed liquid in the passage member 12 relatively large in diameter. The third pore member 16 or the third pore 19 having the smallest diameter applies a predetermined back pressure to the mixed liquid or the emulsified dispersion liquid in the second pore member 15 or the second pore 18 having the largest diameter. As described above, the inner diameter of the ring-shaped seal members 20 is larger than the inner diameter d2 of the second pore member 15 or the second pore 18 having the largest diameter and therefore instantaneously relaxes the pressure of the mixed liquid or the emulsified dispersion liquid to allow the first to third pore members 14 to 16 to provide respective independent pressure drop actions.

The first emulsification/dispersion device 5 can apply to the passage member 12 causing the strongest shearing a back pressure sufficient for preventing bubbling possibly occurring due to the strong shearing. The third pore member 16 or the third pore 19 having the smallest diameter applies a back pressure with respect to the pressure relaxation by the second pore member 15 having the largest diameter so that bubbling is prevented from occurring due to this pressure relaxation. A cylindrical connecting member 21 communicating with the third pore member 16 on the downstream side thereof and leading to the first additive supply port 6 has an inner diameter sufficiently larger than the inner diameter d3 of the third pore member 16 or the third pore 19.

Therefore, the mixed liquid pressurized by the mixed liquid pressurizing pump 4 to a high pressure of, for example, to 300 MPa (300 to 3000 bars), or 100 MPa in this description, is converted into a high-speed jet flow and ejected into the passage member 12 by the nozzle member 11. The jet flow ejected into the passage member 12 applies a strong shearing force to the surrounding mixed liquid to cause emulsification/dispersion of the emulsification/dispersion material, exfoliation of the multilayer graphite, and defibration of the carbon nanotube. The jet flow of the mixed liquid itself flows into the first to third pore members 14 to 16 while losing the kinetic energy thereof, applies the shearing force to the mixed liquid present in the first to third pore members 14 to 16, and similarly causes the emulsification/dispersion of the emulsification/dispersion material etc. to generate an emulsified dispersion liquid. As a result, the mineral oil surrounded by the thin-film graphite and having the carbon nanotube attached to the surface thereof is emulsified and dispersed in water.

The first to third pore members 14 to 16 have small diameter pores in which the kinetic energy of the jet flow is converted into shearing energy and thermal energy due to the liquid/liquid shearing between the jet flow of the mixed liquid passing through axial center parts and the surrounding mixed liquid while the kinetic energy is gradually lost. The setting of the inner diameters and the number of stages of the first to third pore members 14 to 16 or the first to third pores 17 to 19 is an extremely important factor for manufacturing a strong emulsifying/dispersing action without causing bubbling.

As described above, since the high pressure is applied to the mixed liquid in the first and second emulsification/dispersion devices 5, 7 by the mixed liquid pressurizing pump 4, the strong shearing force can be applied to the mixed liquid in the first and second emulsification/dispersion devices 5, 7, so that the emulsification/dispersion material, the graphite, and the carbon nanotube can be sufficiently be atomized, exfoliated and defibrated. Additionally, since the back pressure is applied to the first and second emulsification/dispersion devices 5, 7 by the multistage pressure/temperature control device 9 described later, the occurrence of bubbling in the first and second emulsification/dispersion devices 5, 7 can be prevented.

FIG. 6 shows changes in oil, CNT, and graphite in the case of applying a shearing force to the mixed liquid in the first and second emulsification/dispersion devices 5, 7. The oil (e.g., liquid paraffin) is the emulsification/dispersion material and is micronized into oil particles. The multi-wall carbon nanotube (MWCNT) is turned into defibrated carbon nanotube (CNT). The graphite is an emulsifier and is exfoliated into thin-film graphite. In this case, the carbon nanotube enters between layers of the graphite and also functions as an exfoliating agent for the graphite.

The first to third pore members 14 to 16 shown in FIG. 5 are respectively made up of single cylindrical members different in inner diameter. However, each of the first to third pore members 14 to 16 may be made up of a plurality of (e.g., two to three) cylindrical members. In this case, each of the pore members 14 to 16 preferably has the seal member 20 interposed between the cylindrical members.

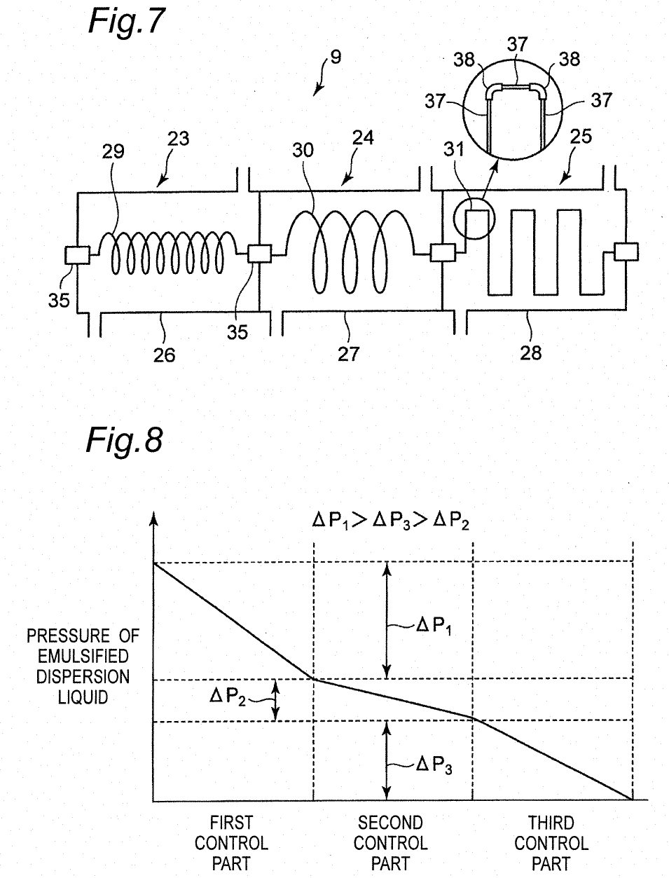

FIG. 7 is a diagram schematically showing the structure of the multistage pressure/temperature control device 9. The multistage pressure/temperature control device 9 receives the emulsified dispersion liquid supplied from the second emulsification/dispersion device 7 via the second additive supply port 8 and reduces the pressure of the emulsified dispersion liquid stepwise or gradually while applying a back pressure to the emulsified dispersion liquid in the first and second emulsification/dispersion devices 5, 7. The multistage pressure/temperature control device 9 cools the emulsified dispersion liquid raised to high temperature due to the emulsification/dispersion by the shearing force, to a predetermined temperature, for example, room temperature (20 to 30° C.). A pressure drop is supplementally controlled by controlling the temperature, and therefore the viscosity, of the emulsified dispersion liquid.

As shown in FIG. 7, the multistage pressure/temperature control device 9 includes first to third control parts 23 to 25 connected in series in order from the upstream side to the downstream side with respect to the flow direction of the emulsified dispersion liquid (rightward in the positional relationship in FIG. 7). The first control part 23 has a first outer jacket 26 through which cooling water (heat transfer medium) flows and a first heat transfer pipe 29 disposed inside the first outer jacket 26 and through which the emulsified dispersion liquid flows. The second control part 24 has a second jacket 27 through which cooling water flows and a second heat transfer pipe 30 disposed inside the second outer jacket 27 and through which the emulsified dispersion liquid flows. The third control part 25 has a third outer jacket 28 through which cooling water flows and a third heat transfer pipe 31 disposed inside the third outer jacket 28 and through which the emulsified dispersion liquid flows.

In the multistage pressure/temperature control device 9, the first to third heat transfer pipes 29 to 31 all have a circular cross section and are connected in series to each other via communication members 35. An upstream end of the first heat transfer pipe 29 and a downstream end of the third heat transfer pipe 31 with respect to the flow direction of the emulsified dispersion liquid are connected respectively via the communication members 35 to pipings on the upstream and downstream sides thereof.

Assuming that the pressure drops in the first to third heat transfer pipes 29 to 31 are ΔP₁ to ΔP₃, respectively, the first to third heat transfer pipes 29 to 31 in the multistage pressure/temperature control device 9 have inner diameters, total lengths, and overall shapes or piping shapes (piping configurations) set to satisfy a relationship of ΔP₁>ΔP₃>ΔP₂ in consideration of physical properties such as flow speed, density, and viscosity of the emulsified dispersion liquid flowing in the first to third heat transfer pipes 29 to 31. In other words, after preferably setting the temperature, flow speed, density, and viscosity of the emulsified dispersion liquid flowing in the first to third heat transfer pipes 29 to 31 so as to obtain the emulsified dispersion liquid having a predetermined physical property or composition, the inner diameters, total lengths, and overall shapes or piping shapes of the first to third heat transfer pipes 29 to 31 are determined to satisfy the relationship of ΔP₁>ΔP₃>ΔP₂.

The setting of the pressure drops ΔP₁ to ΔP₃ of the first to third heat transfer pipes 29 to 31 of the multistage pressure/temperature control device 9 satisfying the relationship of ΔP₁>ΔP₃>ΔP₂ as described above is based on a result of confirmation of the presence/absence of occurrence of bubbling through an experiment conducted by the present inventor in terms of various combinations of pressure drops in the first to third heat transfer pipes 29 to 31 of the multistage pressure/temperature control device 9. From this experiment, it was found that a combination of pressure drops causes no bubbling only when the condition described above is satisfied and that bubbling occurs when the combination does not satisfy this condition.

As described above, the inner diameters, total lengths, and overall shapes or piping forms of the first to third heat transfer pipes 29 to 31 are set to satisfy the relationship of ΔP₁>ΔP₃>ΔP₂ depending on physical properties such as flow speed, density, and viscosity of the emulsified dispersion liquid, and the pressure drop amounts ΔP₁ to ΔP₃ in the first to third heat transfer pipes 29 to 31 can be calculated or estimated by a technique described below.

### <When Emulsified Dispersion Liquid Flows as Laminar Flow>

First, description will be made of a method of calculating the pressure drop amounts ΔP₁ to ΔP₃ when the emulsified dispersion liquid flows as a laminar flow in the first to third heat transfer pipes 29 to 31. In this case, assuming that the inner diameters of the first to third heat transfer pipes 29 to 31 are D₁ to D₃, respectively, that the equivalent lengths of the first to third heat transfer pipes 29 to 31 are Le₁ to Le₃, respectively, that the flow speeds of the emulsified dispersion liquid in the first to third heat transfer pipes 29 to 31 are U₁ to U₃, respectively, that the viscosities of the emulsified dispersion liquid in the first to third heat transfer pipes 29 to 31 are μ₁ to μ₃, respectively, and that the gravity conversion coefficient is g (9.8 kg·m/Kg·sec²), the pressure drop amounts ΔP₁ to ΔP₃ can be calculated respectively by Eqs. 1 to 3 below, i.e., the Hagen-Poiseuille equation.

ΔP₁=32·U₁·Le₁·μ₁/ (g·D₁²) Eq. 1

ΔP₂=32·U₂·Le₂·μ₂/ (g·D₂²) Eq. 2

ΔP₃=32·U₃·Le₃·μ₃/ (g·D₃²) Eq. 3

As used herein, the “equivalent length Le” means a length of a straight pipe causing the same pressure drop or pressure loss as the pressure drop or pressure loss of actual heat transfer pipes in various forms and having the same inner diameter as the heat transfer pipes (the same applies to the case of the emulsified dispersion liquid flowing as a turbulent flow described later). Therefore, in the present invention, various heat transfer pipes having various pipe joints etc. and having various overall shapes are replaced with (considered the same as) straight pipes causing the same pressure drop to occur, so that the Hagen-Poiseuille equation is made available. A method of calculating the “equivalent length” of the pipes or the pipe joints in various forms is well known to those skilled in the art and therefore will not be described in detail. If the cross sections of the first to third heat transfer pipes 29 to 31 are non-circular, for example, elliptical, square, rectangular, etc., “equivalent diameter (4×pipe cross-sectional area/wetted perimeter) may be used instead of the inner diameters D₁ to D₃ (the same applies to the case of the emulsified dispersion liquid flowing as a turbulent flow described later).

As described above, when a flow of the emulsified dispersion liquid in the first to third heat transfer pipes 29 to 31 is a laminar flow, i.e., when the Reynolds number is basically 2300 or less, the pressure drops or pressure losses in the first to third heat transfer pipes 29 to 31 can be calculated respectively by Eqs. 1 to 3 above, i.e., the Hagen-Poiseuille equation, regardless of the roughness of the inner surfaces of the first to third heat transfer pipes. For example, when the emulsified dispersion liquid has the viscosity μ of 3.6 kg/m·hr (1 centipoise), the density ρ of 1000 kg/m³, and the flow speed U of 1800 m/hr (0.5 m/sec), and the inner diameter D of the heat transfer pipe is 0.002 m (2 mm), the flow of the emulsified dispersion liquid in the heat transfer pipe has the Reynolds number of 1000 as follows, and therefore, the flow of the emulsified dispersion liquid is a laminar flow.

Re=D·U·ρ/μ=0.002×1800×1000/3.6=1000

Thus, when the emulsified dispersion liquid flows as a laminar flow in the first to third heat transfer pipes 29 to 31, first, the temperature, flow speed, density, and viscosity of the emulsified dispersion liquid flowing in the first to third heat transfer pipes 29 to 31 may be set, and the inner diameters, total lengths, and overall shapes or piping shapes of the first to third heat transfer pipes 29 to 31 may then be determined by using Eqs. 1 to 3 above such that the pressure drop amounts ΔP₁ to ΔP₃ in the first to third heat transfer pipes 29 to 31 satisfy the relationship of ΔP₁>ΔP₃>ΔP₂.

### <When Emulsified Dispersion Liquid Flows as Turbulent Flow>

Description will be made of a method of calculating the pressure drop amounts ΔP₁ to ΔP₃ when the emulsified dispersion liquid flows as a turbulent flow in the first to third heat transfer pipes 29 to 31. In this case, if the first to third heat transfer pipes 29 to 31 are smooth pipes, the pressure drops ΔP₁ to ΔP₃ in the first to third heat transfer pipes 29 to 31 can be calculated respectively by Eqs. 4 to 6 below, i.e., the Karman-Nikuradse equation. In this emulsified dispersion liquid manufacturing system S, pipes used for all the first to third heat transfer pipes 29 to 31 are smooth pipes, for example, smooth stainless-steel pipes or copper pipes, with inner wall surfaces having the same degree of roughness as glass pipes.

ΔP₁=4·f₁·[(ρ₁·U₁²/(2·g)]·(Le₁/D₁) Eq. 4

where 1/f₁^{0.5}=4·log [(D₁·U₁·ρ₁/μ₁)·f₁^{0.5}]−0.4

ΔP₂=4·f₂·[(ρ₂·U₂²/(2·g)]·(Le₂/D₂) Eq. 5

where 1/f₂^{0.5}=4·log [(D₂·U₂ρ₂/μ₂)·f₂^{0.5}]−0.4

ΔP₃=4·f₃·[(ρ₃·U₃²/(2·g)]·(Le₃/D₃) Eq. 6

where 1/f₂^{0.5}=4·log [(D₃·U₃ρ₃/μ₃)·f₃^{0.5}]−0.4

In Eqs. 4 to 6, ρ₁ to ρ₃ denote the densities of the emulsified dispersion liquid flowing in the first to third heat transfer pipes 29 to 31, respectively. Additionally, f₁ to f₃ denote pipe friction coefficients of the first to third heat transfer pipes 29 to 31 and are functions of only the Reynolds number since the first to third heat transfer pipes 29 to 31 are smooth pipes. The meaning of the other symbols is the same as the case of the emulsified dispersion liquid flowing as a laminar flow.

As described above, when the flow of the emulsified dispersion liquid in the first to third heat transfer pipes 29 to 31 is a turbulent flow, i.e., when the Reynolds number basically exceeds 2300, the pressure drops or pressure losses in the first to third heat transfer pipes 29 to 31 at 31 can be calculated respectively by Eqs. 4 to 6, i.e., the Karman-Nikuradse equation, if the first to third heat transfer pipes 29 to 31 are smooth pipes. For example, when the emulsified dispersion liquid has the viscosity μ of 3.6 kg/m·hr (1 centipoise), the density ρ of 1000 kg/m³, and the flow speed U of 3600 m/hr (1 m/sec), and the inner diameter D of the heat transfer pipe is 0.003 m (3 mm), the flow of the emulsified dispersion liquid in the heat transfer pipe has the Reynolds number of 3000 as follows, and therefore, the flow of the emulsified dispersion liquid is a turbulent flow.

Re=D·U·ρ/μ=0.003×3600×1000/3.6=3000

Thus, when the emulsified dispersion liquid flows as a turbulent flow in the first to third heat transfer pipes 29 to 31, first, the temperature, flow speed, density, and viscosity of the emulsified dispersion liquid flowing in the first to third heat transfer pipes 29 to 31 may be set, and the inner diameters, total lengths, and overall shapes or piping shapes of the first to third heat transfer pipes 29 to 31 may then be determined by using Eqs. 4 to 6 above such that the pressure drop amounts ΔP₁ to ΔP₃ in the first to third heat transfer pipes 29 to 31 satisfy the relationship of ΔP₁>ΔP₃>ΔP₂.

As described above, in the multistage pressure/temperature controller 9, the inner diameters, total lengths, and overall shapes or piping shapes of the first to third heat transfer pipes 29 to 31 are preferably determined in consideration of the viscosity and density of the emulsified dispersion liquid such that the pressure drops ΔP₁ to ΔP₃ in the first to third heat transfer pipes 29 to 31 satisfy the relationship of ΔP₁>ΔP₃>ΔP₂, and in this embodiment, the first heat transfer pipe 29 and the second heat transfer pipe 30 are coil-shaped pipes (corrugated pipes).

To maximize the pressure drop amount ΔP₁, the first heat transfer pipe 29 has the inner diameter set relatively small, the entire pipe length set relatively long, the coil diameter set relatively small, and the coil pitch set relatively small. Therefore, the first heat transfer pipe 29 is a closely wound coil-shaped pipe having a small coil diameter. On the other hand, to minimize the pressure drop amount ΔP₂, the second heat transfer pipe 30 has the inner diameter set relatively large, the entire pipe length set relatively short, the coil diameter set relatively small, and the coil pitch set relatively small. Therefore, the second heat transfer pipe 30 is a loosely wound coil-shaped pipe having a large coil diameter.

The third heat transfer pipe 31 is a pipe having an overall shape or a piping shape that is a rectangular wave shape, i.e., a pipe having a shape in which rectangular irregularities are repeated. As shown in a partially enlarged view of FIG. 7, the third heat transfer pipe 31 has an assembled body structure in which multiple straight pipes 37 are connected by using a 90° elbow 38 at each bent portion. The total length of the third heat transfer pipe 31, the inner diameter of the straight pipes 37, and the shape of the 90° elbows 38 are preferably set such that the pressure drop amount ΔP₃ in the third heat transfer pipe 31 becomes smaller than the pressure drop among ΔP₁ in the first heat transfer pipe 29 and becomes larger than the pressure drop amount ΔP₂ of the second heat transfer pipe 30. The third heat transfer pipe 31 can be disassembled so that the inside thereof can easily be cleaned.

An example of the dimensions or the overall shapes of the first to third heat transfer pipes 29 to 31 is listed below.

### <First Heat Transfer Pipe>

Inner diameter D₁: 1 mm
Total pipe length L₁: 5 m
Equivalent length Le₁: 6 m
Overall shape: coil shape (corrugated pipe)
   Coil diameter: 50 mm
   Coil pitch: 15 mm

### <Second Heat Transfer Pipe>

Inner diameter D₂: 3 mm
Total pipe length L₂: 3 m
Equivalent length Le₂: 3.5 m
Overall shape: coil shape (corrugated pipe)
   Coil diameter: 100 mm
   Coil pitch: 30 mm

### <Third Heat Transfer Pipe>

Inner diameter D₃: 2 mm
Total pipe length L₃: 4 m
Equivalent length Le₃: 4.5 m
Overall shape: rectangular wave shape
   Width of one rectangle: 10 mm
   Length of one rectangle: 20 mm

FIG. 8 shows an example of positional change in pressure of the emulsified dispersion liquid in the first to third control parts 23 to 25 (the first to third heat transfer pipes 29 to 31) of the multistage pressure/temperature control device 9. As shown in FIG. 5, in the multistage pressure/temperature control device 9, the pressure of the emulsified dispersion liquid decreases stepwise or gradually to the atmospheric pressure or substantially the atmospheric pressure at an outlet part of the third control part 25 (the third heat transfer pipe 31). In this way, the pressure of the emulsified dispersion liquid is reduced stepwise or gradually so that no rapid or instantaneous pressure drop occurs in the multistage pressure/temperature control device 9, and therefore, when the emulsified dispersion liquid is discharged from the emulsified dispersion liquid manufacturing system S to the outside, no bubbling occurs in the emulsified dispersion liquid. The temperature of the emulsified dispersion liquid discharged from the emulsified dispersion liquid manufacturing system S to the outside can preferably be controlled. Therefore, the quality of the emulsified dispersion liquid as a product can be enhanced substantially without using a surfactant, and an energy loss can be reduced to enhance energy efficiency.

The multistage pressure/temperature control device 9 can set the back pressure necessary for the first and second emulsification/dispersion devices 5, 7, i.e., the back pressure capable of preventing the occurrence of bubbling and can reduce the back pressure stepwise or gradually and finally to a pressure causing no bubbling even in the case of being released to the atmosphere. In this case, the inner diameter or equivalent inner diameter, the entire length (pipe length) or equivalent length, and the overall shape of the first to third heat transfer pipes 29 to 31 can preferably be combined so as to cope with the back pressure or a degree of reduction in the back pressure with a high degree of freedom.

In this emulsified dispersion liquid manufacturing system S, water or other various medium liquids (e.g., methanol, ethanol, or aqueous solution thereof) can be used, and these medium liquids may be brought into a critical state to emulsify and disperse the emulsification/dispersion material. For example, when the medium liquid is water and the emulsification/dispersion material is lecithin that is a glycerophospholipid, the emulsification/dispersion material may be emulsified and dispersed generally by the following steps.

Specifically, first, predetermined amounts of water, lecithin, and other necessary additives are put into the mixed liquid supply tank 1 and agitated by the agitator (not shown) to prepare a mixed liquid in which particulates of lecithin and the additives are substantially uniformly distributed in water that is macroscopically the medium liquid. This mixed liquid is then supplied to the mixed liquid pressurizing pump 4 via the heat exchanger 3 at a predetermined flow rate by the pressure transfer pump 2. At this step, the mixed liquid is raised in temperature to 374.2° C., i.e., the critical temperature of water serving as the medium liquid, or higher (e.g., 400° C.), and raised in pressure to 218.4 atmospheres, i.e., the critical pressure of water, or higher (e.g., 1000 atmospheres) by the heat exchanger 3 and the mixed liquid pressurizing pump 4 to bring the mixed liquid into a critical state.

The mixed liquid in the critical state is supplied to the first emulsification/dispersion device 5 and further to the second emulsification/dispersion device 7. If necessary, predetermined additives are added from the first and second additive supply devices 6, 8. Since the water serving as the medium liquid is in a critical state, a water-insoluble emulsification/dispersion material such as lecithin is in a state of being easily emulsified or dispersed in the water. In such a state, the mixed liquid is injected at high speed into the first emulsification/dispersion device 5 and further into the second emulsification/dispersion device 7, so that a strong shearing force facilitates emulsification and dispersion of the water-insoluble emulsification/dispersion material such as lecithin. Therefore, the water-insoluble emulsification/dispersion material such as lecithin can be emulsified and dispersed in the water serving as the medium liquid without using a surfactant.

At this step, the multistage pressure/temperature control device 9 applies the back pressure to the high temperature/high pressure mixed liquid or emulsified dispersion liquid in the first and second emulsification/dispersion devices 5, 7, so that no bubbling occurs in the first and second emulsification/dispersion devices 5, 7. The emulsified dispersion liquid discharged from the second emulsification/dispersion device 7 is cooled to a predetermined temperature (e.g., room temperature) in the multistage pressure/temperature control device 9 and depressurized stepwise or gradually to a predetermined pressure (e.g., atmospheric pressure). Since the emulsified dispersion liquid is cooled and depressurized stepwise or gradually, no bubbling occurs in the pressure/temperature control device 9 or at the time of discharge from the pressure/temperature control device 9 to the outside. Thus, after the shearing force is applied to the mixed liquid for emulsification and dispersion in the critical state, a favorable emulsified dispersion state can be maintained to obtain a final product without causing bubbling.

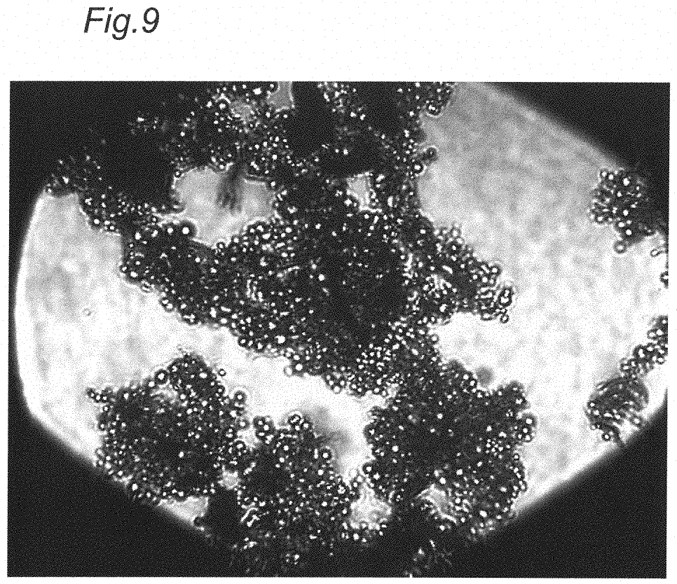

The emulsified dispersion liquid according to the embodiment of the present invention can be obtained by the step described above. FIG. 9 is a photomicrograph of the emulsified dispersion liquid produced by the emulsified dispersion liquid manufacturing system S. In the photomicrograph, white circle portions represent liquid paraffin (oil particles) serving as the emulsification/dispersion material, and the periphery thereof is surrounded by black thin-film graphite. The diameter of the liquid paraffin is about 1 to 10 μm. Carbon nanotube adheres around the thin-film graphite to prevent the graphite thin films from aggregating with each other.

In the description of the embodiment of the present invention, the mixed liquid is passed through the emulsified dispersion liquid manufacturing system S once; however, the mixed liquid may be passed through multiple times if necessary. By allowing the mixed liquid to pass through multiple times, the emulsification/dispersion material can further be micronized.

In this description, the medium liquid (water), the emulsification/dispersion material (liquid paraffin), the emulsifier (graphite), the multi-wall carbon nanotube, and the thickener (CMC) are put into the mixed liquid supply tank 1 as a mixed liquid; however, after passing a mixed liquid composed of the medium liquid, the emulsifier (graphite), and the multi-wall carbon nanotube other than the emulsification/dispersion material through the emulsified dispersion liquid manufacturing system S, the emulsification/dispersion material may be added before performing the step described above. As a result, the exfoliation of graphite and the disintegration of multi-wall carbon nanotube can be performed in advance, so that the emulsification/dispersion step can efficiently be performed.

Even in the case of the emulsified dispersion liquid containing the medium liquid, the emulsification/dispersion material, and the carbon nanotube, the mixed liquid can be passed through the emulsified dispersion liquid manufacturing system S so as to obtain the emulsified dispersion liquid in which the emulsification/dispersion material is dispersed in the medium liquid in a state of being surrounded by the carbon nanotube.

### INDUSTRIAL APPLICABILITY

The emulsified dispersion liquid according to the present invention can be used not only for cosmetics and food coming into contact with the human body, but also for lubricants for machines, battery materials etc.

### EXPLANATIONS OF LETTERS OR NUMERALS

S emulsified dispersion liquid manufacturing system, mixed liquid supply tank, 2 pressure transfer pump, 3 heat exchanger, 4 mixed liquid pressurizing pump, 5 first emulsification/dispersion device, 6 first additive supply port, 7 second emulsification/dispersion device, 8 second additive supply port, 9 multistage pressure/temperature control device, 11 nozzle member, 12 passage member, 13 main body part, 14 first pore member, 15 second pore member, third pore member, 17 first pore, 18 second pore, 19 third pore, 20 seal member, 21 connection member, 23 first control part, 24 second control part, 25 third control part, first outer jacket, 27 second outer jacket, 28 third outer jacket, 29 first heat transfer pipe, 30 second heat transfer pipe, 31 third heat transfer pipe, 35 communication member, 37 straight pipe, 38 90° elbow.

What is claimed is:

1. An emulsified dispersion liquid comprising:
a medium liquid;
an emulsification/dispersion material insoluble in the medium liquid;
a thin-film graphite; and
a carbon nanotube, wherein
the emulsification/dispersion material is dispersed in the medium liquid in a state of being surrounded by the thin-film graphite with the carbon nanotube adhering to the surface of the thin-film graphite.

2. The emulsified dispersion liquid according to claim 1, further comprising a thickener.

3. The emulsified dispersion liquid according to claim 2, wherein the thickener is a water-soluble polymer.

4. The emulsified dispersion liquid according to claim 1, wherein the emulsification/dispersion material is an oil or an oil containing a lipophilic substance.

5. The emulsified dispersion liquid according to claim 4, wherein the oil is a mineral oil or liquid paraffin.

6. The emulsified dispersion liquid according to claim 4, wherein the melting point of the oil is lower than the melting point of the thin-film graphite and/or the carbon nanotube.

7. An emulsified dispersion liquid comprising:
a medium liquid;
an emulsification/dispersion material insoluble in the medium liquid; and
a carbon nanotube, wherein
the emulsification/dispersion material is dispersed in the medium liquid in a state of being surrounded by the carbon nanotube.

8. The emulsified dispersion liquid according to claim 7, further comprising a thickener.

9. The emulsified dispersion liquid according to claim 8, wherein the thickener is a water-soluble polymer.

10. The emulsified dispersion liquid according to claim 7, wherein the emulsification/dispersion material is an oil or an oil containing a lipophilic substance.

11. The emulsified dispersion liquid according to claim 10, wherein the oil is a mineral oil or liquid paraffin.

12. The emulsified dispersion liquid according to claim 10, wherein the melting point of the oil is lower than the melting point of the thin-film graphite and/or the carbon nanotube.
